(19) United States
(12) Patent Application Publication
(10) Pub. No.: US 2002/0111846 A1
(43) Pub. Date: Aug. 15, 2002

(54) System and method for automatic maintenance reminders

(76) Inventor: Joel L. Singer, Sudbury, MA (US)

Correspondence Address: Warner Norcross & Judd LLP, Intellectual Property Practice Group, 900 Fifth Third Center, 111 Lyon Street, N.W., Grand Rapids, MI, 49503-2487, US

(21) Appl. No.: 10/074,487

(22) Filed: Feb. 13, 2002

Related U.S. Application Data
(60) Provisional application No. 60/268,466, filed on Feb. 13, 2001.

(51) Int. Cl. G06F 17/60

(52) U.S. Cl. 705/8

(57) ABSTRACT

A computer system and associated method for providing automatic maintenance reminders. The computer system generally includes an object database containing scheduled maintenance for a plurality of object, such as homes, cars, appliances and industrial equipment. The system also includes an input means permitting a user to enter a list of objects from the database for which the user would like automated reminders. The system further includes a means for generating a reminder of scheduled maintenance for each object in a user's list of objects based on the information contained in the object database. The system includes means for periodically transmitting the maintenance reminders to the user via various communications mechanisms, such as email, facsimile, pager, personal digital assistant, text-to-voice messaging and data access pages.

### RELATED UNITED STATES APPLICATIONS/CLAIM OF PRIORITY

This application claims priority from U.S. Provisional Application Serial No. 60/268,466, entitled SYSTEM AND METHOD FOR AUTOMATED MAINTENANCE REMINDERS, which was filed on Feb. 13, 2001 by Joel L. Singer, and which is incorporated herein by reference in its entirety.

### REFERENCE TO AND SPECIFIC INCORPORATION BY REFERENCE OF APPENDICES IN U.S. PROVISIONAL APPLICATION SERIAL NO. 60/268,466

Appendices 3 and 4, and the Addendums to Appendices 3 and 4, are part of U.S. Provisional Application Serial No. 60/268,466, and are incorporated herein by reference in their entirety. Appendices 3 and 4 include application listings of computer programs and related data for implementing one embodiment of this invention as described more completely below.

Appendix 5 and the Addendum to Appendix 5 are part of U.S. Provisional Application Serial No. 60/268,466, and are incorporated herein by reference in their entirety. Appendix 5 includes a print out of ASP files.

Appendix 6 is part of U.S. Provisional Application Serial No. 60/268,466, and is incorporated herein by reference in its entirety. Appendix 6 includes pictorial representations of associated maintenance items referenced in an embodiment of the present invention.

Appendix 7 and the Addendum to Appendix 7 are part of U.S. Provisional Application Serial No. 60/268,466, and are incorporated herein by reference in their entirety. Appendix 7 includes data architecture layout and screen shots of a preferred embodiment web page.

At least one portion of the disclosure of this patent document contains material, which is subject to copyright protection. The copyright owner has no objection to the facsimile reproduction by anyone of the patent document or the patent disclosure, as it appears in the Patent and Trademark office patent files or records, but otherwise reserves all copyright rights whatsoever.

### FIELD OF THE INVENTION

This invention relates to a method of and system for providing automated maintenance reminders to a user. More specifically, this invention helps users to perform the correct routine maintenance at the appropriate time, so as to help them to improve the safety and efficiency of their equipment and property, and to save them time and money. In addition to providing timely reminders, the invention notifies the user of maintenance tasks, of which the user may have otherwise not known.

### BACKGROUND AND SUMMARY OF THE INVENTION

This invention relates to a method and system for providing automated maintenance reminders to a user. More specifically, this invention helps users to identify and perform the correct routine maintenance at the appropriate time, so as to help them to improve the safety and efficiency of their equipment, and to save them time and money. In addition to providing timely reminders, the invention makes the user aware of maintenance tasks that they may not have otherwise known about. Thus, the invention enables users to better protect the investment in their equipment and property, and saving themselves from future, avoidable trouble and expense.

At present, various attempts to solve customer relationship management problems have been undertaken by various entities and individuals. However, these attempts have been usually been focused on a narrow part of the overall problem. For example, service providers today frequently send out postcard type notifications to their customers when they are due for their services. One limited example of such service providers could be a septic tank service company sending its customers an annual postcard. Other examples of a narrow attempt to address the void regarding an automated reminder system for a user's maintenance needs are the online libraries of information on recommended maintenance and maintenance schedules available to the public. But, these types of libraries are not customized to the user's particular needs and requirements. Nothing exists in any industry today that takes a comprehensive approach to sending automatic reminders for all of the user's maintenance type requirements.

This invention helps solve two known problems. First most people do not know all of the recommended maintenance schedules for their equipment, property or other tracked areas. Second, most people need reminders when it is time to do maintenance; otherwise the maintenance will go uncompleted which leads to premature erosion or attrition to the equipment, property or other areas needing maintenance.

In a preferred embodiment, the present invention utilizes such technology as computers, computer servers, network technology such as the Internet, and database storage and retrieval technology. In this preferred embodiment, the user has an accurate, reliable and user-friendly system and method for accessing and receiving online maintenance information through network technology such as an Internet web server. In addition, the present invention also provides alternative accurate, reliable and user-friendly systems and methods for accessing and receiving automatic maintenance reminders by way of regular mail, pager, wireless communications, facsimile, telephone or the like. The present invention is not limited to a specific mode of delivery. Accordingly, any tasks accomplished by use of email, the Internet or other electronic means may be alternatively accomplished by other acceptable modes of communication.

### BRIEF DESCRIPTION OF THE DRAWINGS

FIG. 1 is a screen shot showing a list of the Key Data Tables;

FIG. 2 is a screen shot showing the Maintenance Schedules Table;

FIG. 3 is a screen shot showing the Descriptions of Maintenance Tasks Table for “Inside Reasons”;

FIG. 4 is a screen shot showing the Descriptions of Maintenance Tasks Table for “Outside Reasons”;

FIG. 5 is a screen shot showing the Descriptions of Maintenance Tasks Table for “Other Reasons”;

FIG. 6 is a screen shot showing the User Name and Features Table;

FIG. 7 is a screen shot showing the User Period Request Table;

FIG. 8 is a screen shot showing the User Preferences Table;

FIG. 9 is a screen shot showing the “Flipper” Table for flipping the Descriptions of Maintenance Tasks Table for “Inside Reasons”;

FIG. 10 is a screen shot showing the “Flipper” Table for flipping the Descriptions of Maintenance Tasks Table for “Outside Reasons”;

FIG. 11 is a screen shot showing the “Flipper” Table for flipping the Descriptions of Maintenance Tasks Table for “Other Reasons”;

FIG. 12 is a screen shot showing a list of the Key Queries;

FIG. 13 is a screen shot showing the Master Features List query;

FIG. 14 is a screen shot showing the Current User query;

FIG. 15 is a screen shot showing the Current Period query;

FIG. 16 is a screen shot showing the Features of Current User query;

FIG. 17 is a screen shot showing the Tasks Due for Current Period query;

FIG. 18 is a screen shot showing the “Flipped Data” query for use with the Features of the Current User Table and the Descriptions of Maintenance Tasks Table for “Inside Reasons”;

FIG. 19 is a screen shot showing the “Flipped Data” query for use with the Features of the Current User Table and the Descriptions of Maintenance Tasks Table for “Outside Reasons”;

FIG. 20 is a screen shot showing the “Flipped Data” query for use with the Features of the Current User Table and the Descriptions of Maintenance Tasks Table for “Other Reasons”;

FIG. 21 is a screen shot showing the “Flipped Data” query for use with the Tasks Due For Current Period Table and the Descriptions of Maintenance Tasks Table for “Inside Reasons”;

FIG. 22 is a screen shot showing the “Flipped Data” query for use with the Tasks Due For Current Period Table and the Descriptions of Maintenance Tasks Table for “Outside Reasons”;

FIG. 23 is a screen shot showing the “Flipped Data” query for use with the Tasks Due For Current Period Table and the Descriptions of Maintenance Tasks Table for “Other Reasons”;

FIG. 24 is a screen shot showing the Tasks Currently Due query for “Inside Reasons”;

FIG. 25 is a screen shot showing the Tasks Currently Due query for “Outside Reasons”;

FIG. 26 is a screen shot showing the Tasks Currently Due query for “Other Reasons”;

FIG. 27 is a screen shot showing the Displays of Descriptions of Maintenance Tasks query for “Inside Reasons”;

FIG. 28 is a screen shot showing the Displays of Descriptions of Maintenance Tasks query for “Outside Reasons”; and

FIG. 29 is a screen shot showing the Displays of Descriptions of Maintenance Tasks query for “Other Reasons”.

### DETAILED DESCRIPTION OF THE PRESENT INVENTION

Referring more specifically to the present invention, for illustrative purposes the present invention is embodied in the system configuration, method of operation and product or computer-readable medium, such as floppy disks, conventional hard disks, CD-ROMS, Flash ROMS, nonvolatile ROM, RAM and any other equivalent computer memory device, generally shown herein. It will be appreciated that the system, method of operation and product may vary as to the details of its configuration and operation without departing from the basic concepts disclosed herein.

With regard to a description of the invention, the system and method allows a user to input unique features of their equipment, property and other maintenance-type information. Then the system, based upon the information provided by the user, will process, determine and store all necessary maintenance tasks and recommendations for the user, including certain tasks and recommendations for equipment or property features that are deemed by the system to be universal to all such itemized equipment, property or other areas of maintenance. Next, the system establishes a schedule of maintenance reminders for a preset period of time for each user. Finally, at each interval of the pre-set period of time, the system will generate and issue to the user a customized collection of maintenance reminders for the user to accomplish during the next interval of the pre-set period of time. The maintenance reminders may be provided to the user via email, access to an online password protected website, pager, wireless communication, regular mail, facsimile, telephone or the like.

In a preferred embodiment of the present invention, user first inputs at the web page the unique features of his or her home by checking off all features provided on the web site that apply. Based upon the user's input, the system and method then calculates an ideal maintenance schedule for the home for each month on an on-going basis. Next, a monthly reminders prompt appears so that the user can select appropriate and desired monthly reminders. Such reminders for each maintenance term may include: maintenance reminders due, recommended maintenance intervals, purpose of the maintenance task, whether the particular maintenance service can he performed online, and whether supplies for a task can be purchased online. Further, users can select a personal identification number (PIN) for selective access to the above information. Users can also provide an email address for automatic notification at selected intervals, such as monthly. Other modes of automatic maintenance reminder notification can also include regular mail, facsimile, beeper, wireless communication, telephone or the like.

The present invention, in a preferred embodiment is constructed of input and output web pages, database tables and SQL code commands. These components are connected through a common web server that is integrated into a third-party database, such as Microsoft Access Database™, Microsoft SQL Server™, Oracle™, or the like. The web pages constructed to perform the inventive method and comprising the inventive system are not dependent upon any specific computer language.

In addition, in an alternate embodiment, the present invention may also allow customers to automatically schedule maintenance services through associated applications online.

Further, yet another alternate embodiment of the present invention is a system and method for capturing user information regarding maintenance information. This system and method can offer to the customer personally relevant cross-selling applications.

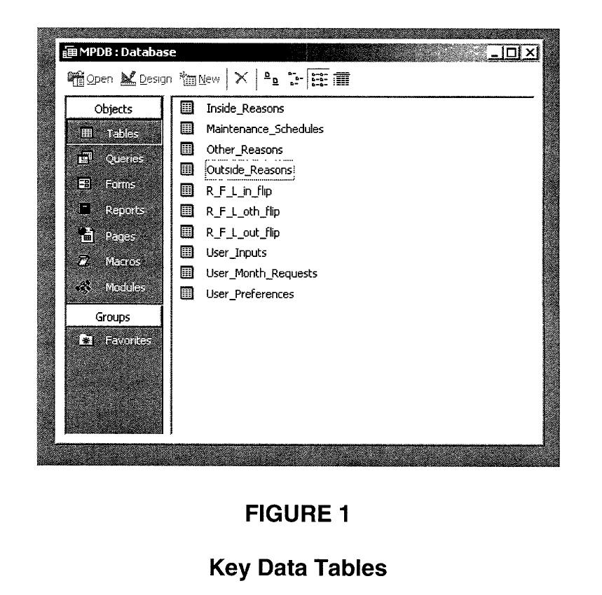

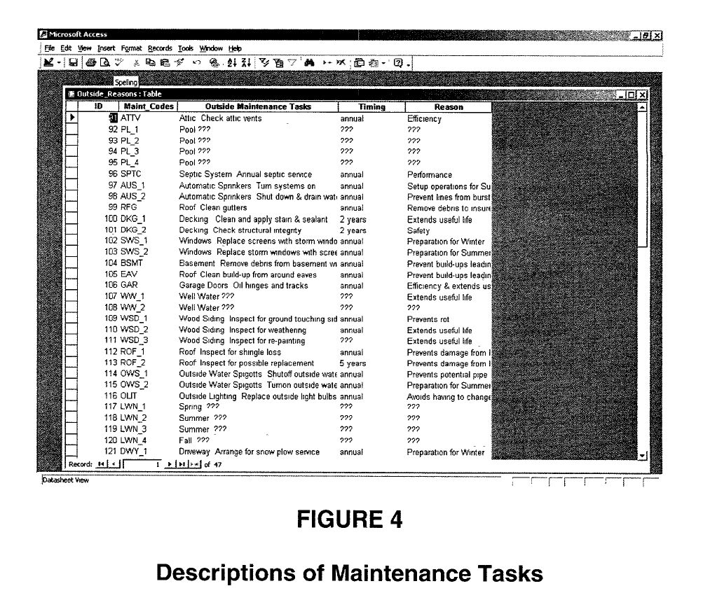

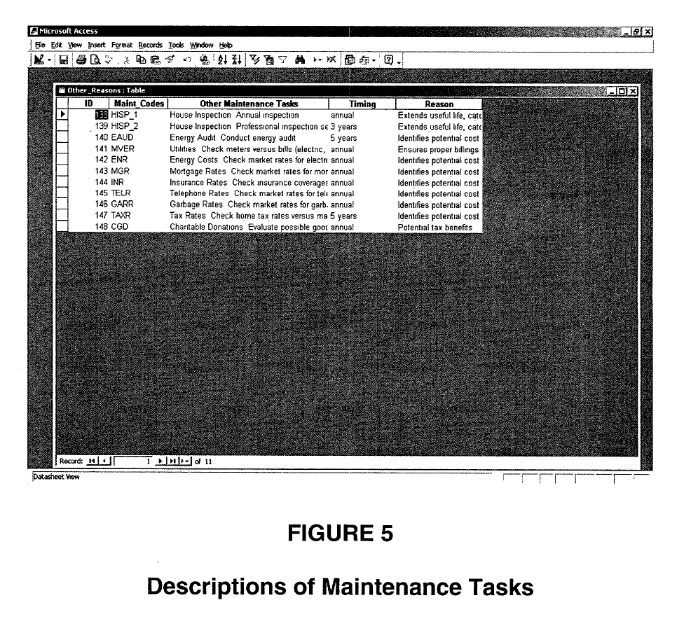

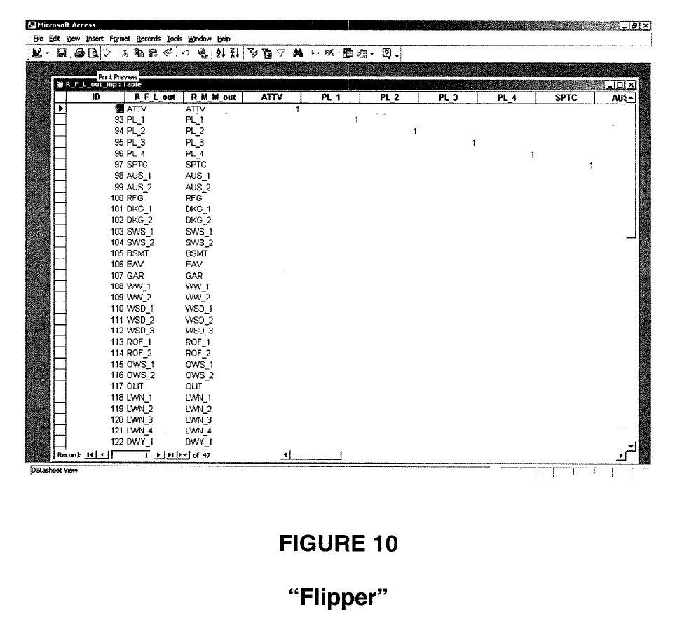

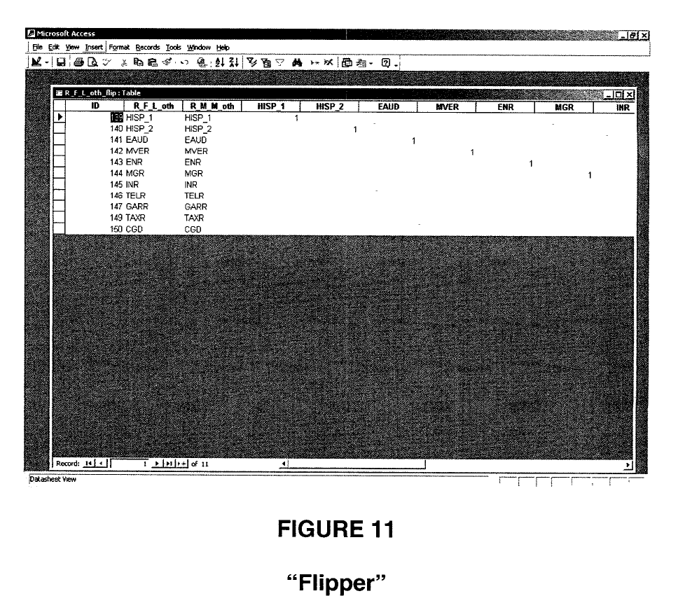

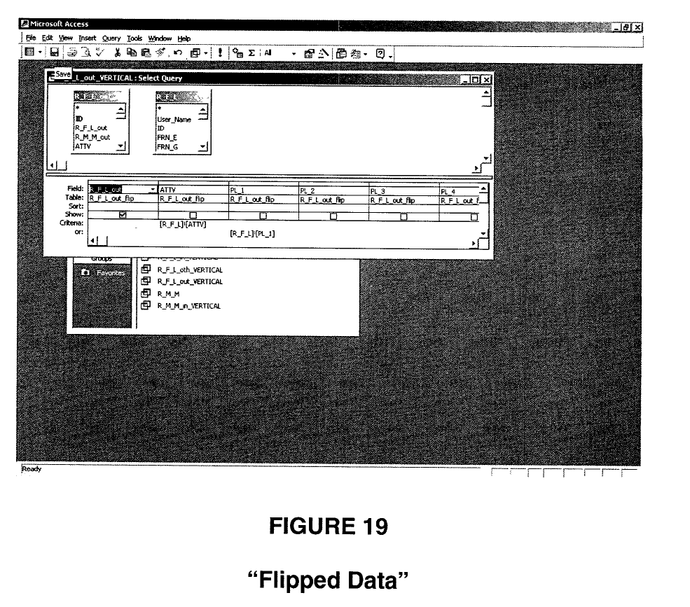

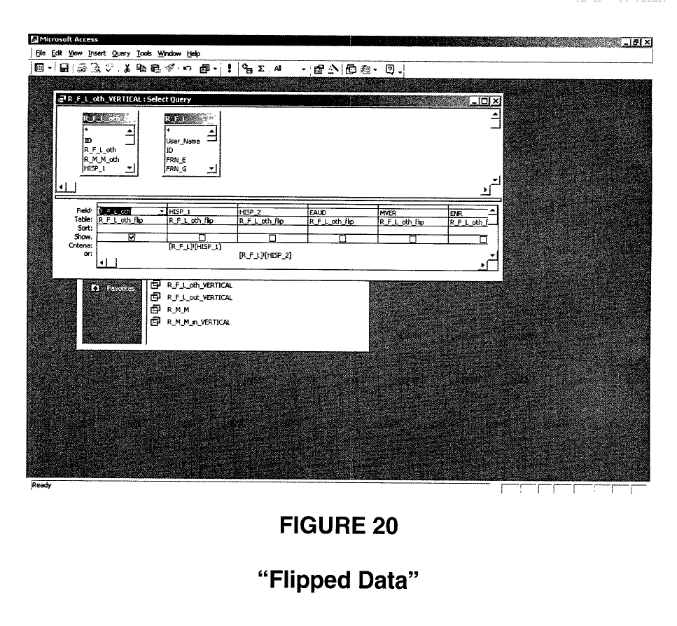

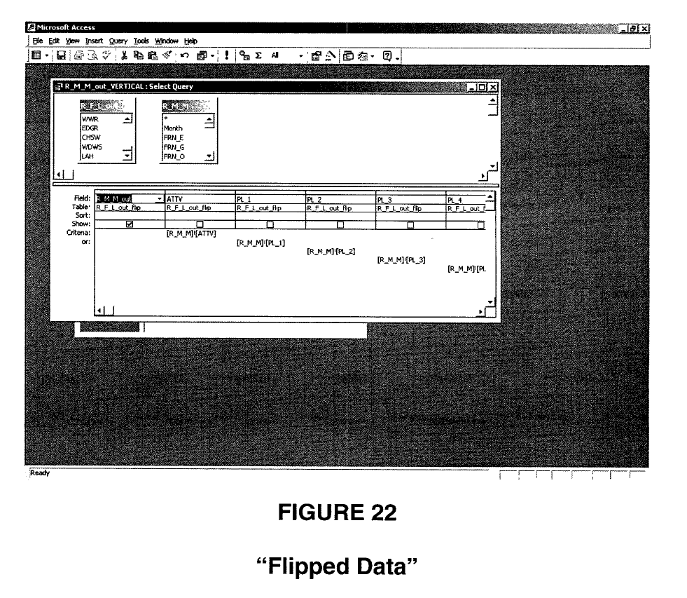

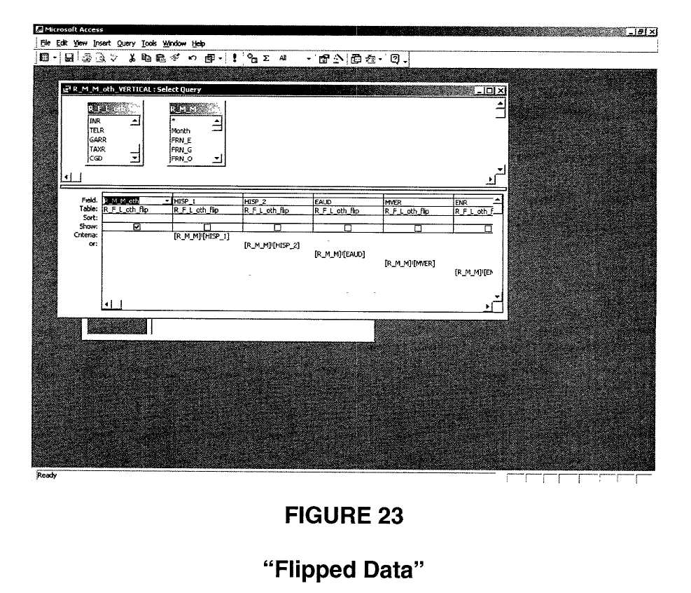

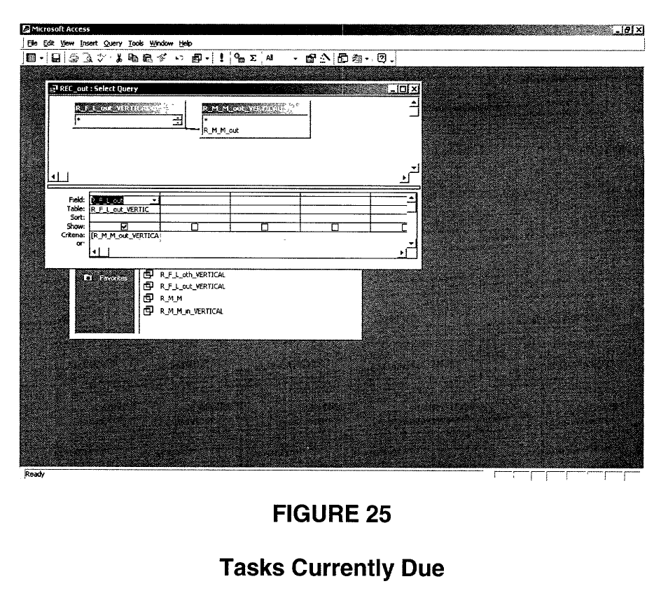

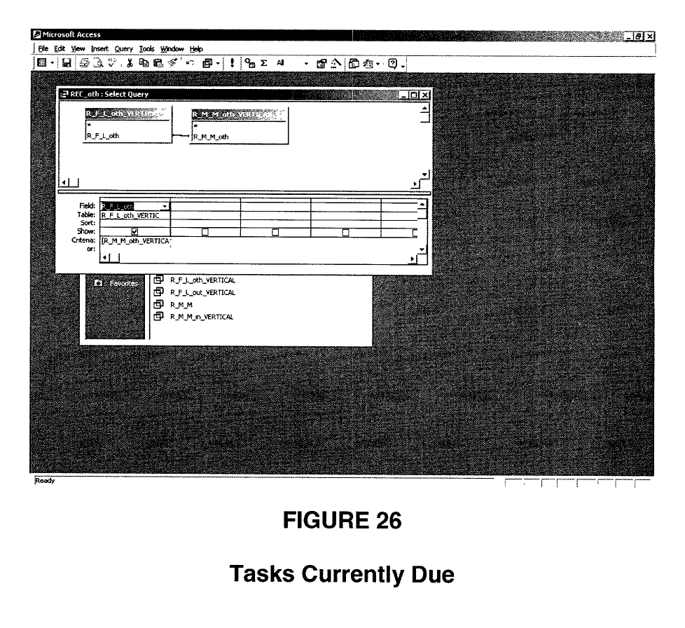

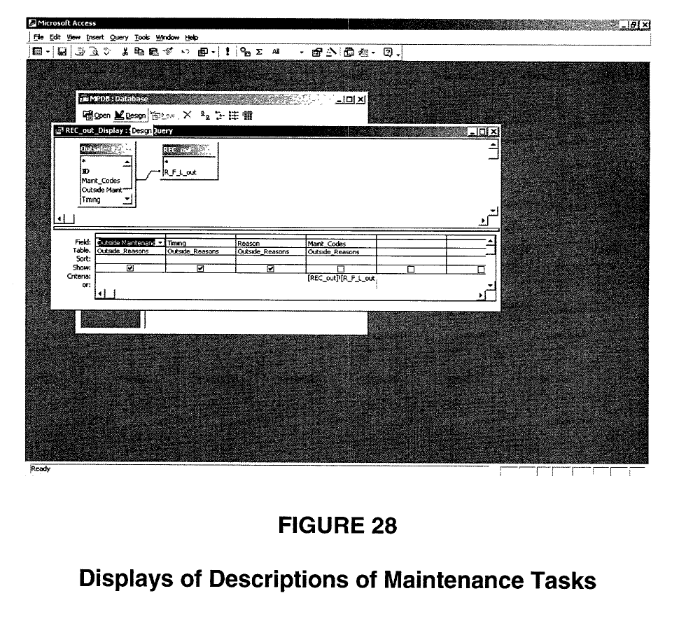

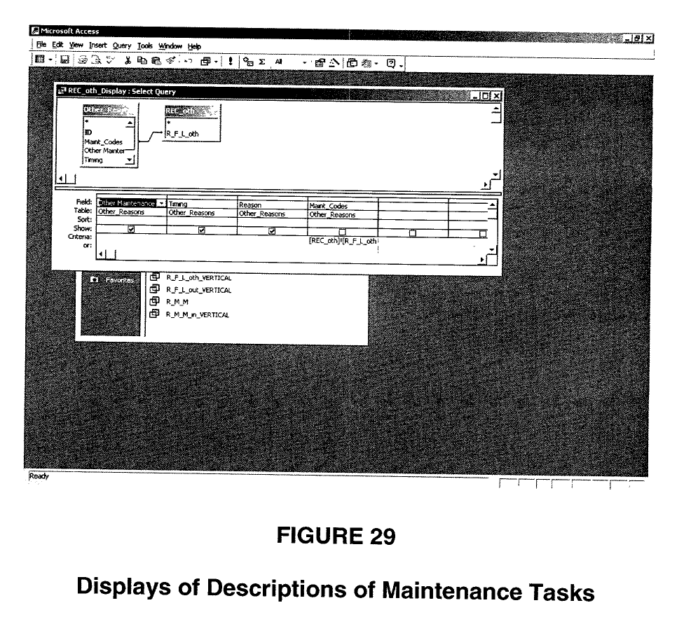

The implementation of a preferred embodiment of the present invention into a web based software program will now be described with reference to FIGS. 1-29. As noted above, the program allows users to input the specific features of their entities that require maintenance (e.g., home, cars, industrial equipment, human resources, etc.), and t hen the program sends them automatic reminders when it is the appropriate time for them to do the recommended maintenance tasks that correspond to their specific features.

The software program uses a database and Structured Query Language (SQL) commands to manipulate data in the database. Key elements of the MP software program include:

Input/Output Interfaces

Data Tables

Queries

Input/Output Interfaces

Input into the program can be accomplished in various manners, which include: Internet web page forms; data access pages; etc.

Output interfaces from the program can include: Internet database results pages; Internet e-mail; faxes; text-to-voice messaging; PDA; pager; data access pages; etc.

Key Data Tables

The software program utilizes four key types of data tables (See FIG. 1):

Maintenance Schedules

Descriptions of Maintenance Tasks

User Inputs

“Flippers”

These tables are preferably maintained in conventional computer memory or storage devices.

Maintenance Schedules

This table holds the data for the recommended maintenance intervals for each recommended maintenance task.

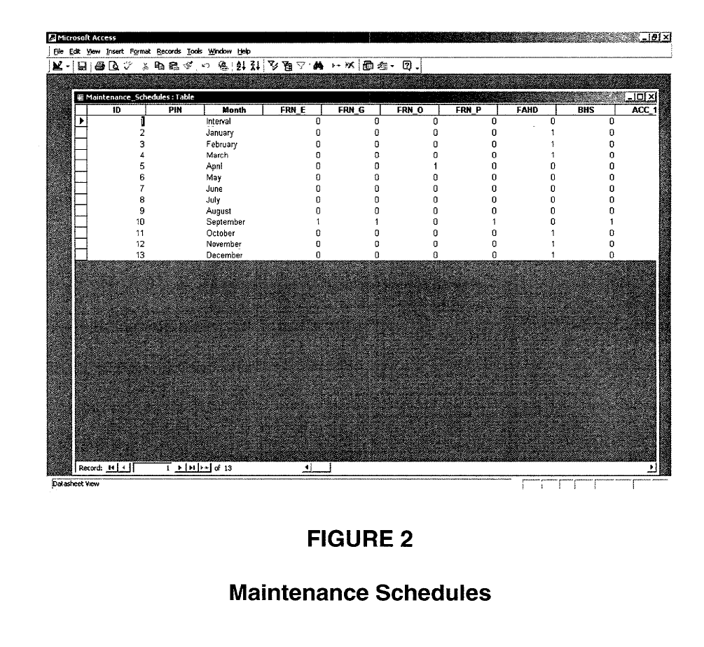

The maintenance intervals are listed in the first data column, and the remaining columns are for each of the recommended maintenance tasks. For each of these latter columns, a “1” is placed in the row corresponding to the recommended maintenance interval. It should be noted that, in this embodiment, the table includes a separate column for each task, and not merely each object. Accordingly, a single object may have more than a single entry in the Maintenance Schedules Table. More precisely, the table will include a separate column for each maintenance task for each object. See FIG. 2.

Descriptions of Maintenance Tasks

This table holds the data that describes each of the recommended maintenance tasks, including its recommended timing and the reason for doing this particular task.

The first column holds the maintenance code for each of the tasks, and the subsequent columns hold the description of the task, the timing, and the reason. Again, the table includes a column for each maintenance task, and not merely each object.

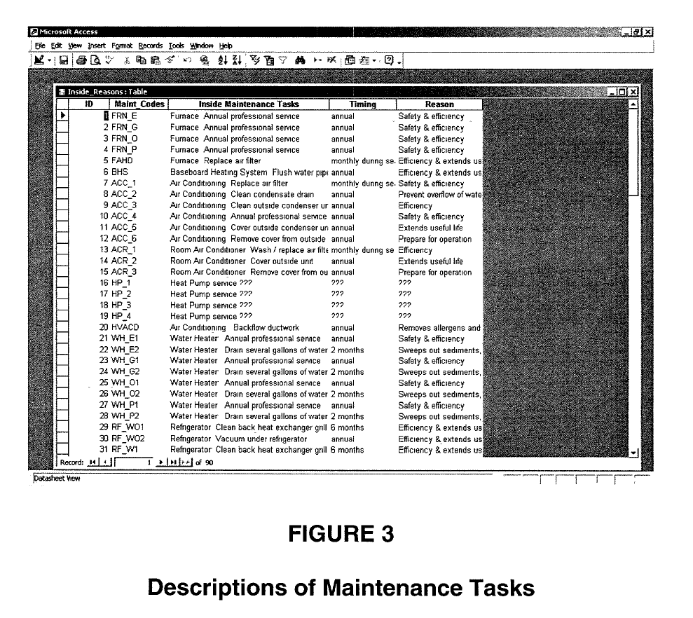

Because of the large size of the database, the descriptions of the maintenance tasks are broken into three tables. See FIGS. 3, 4, and 5. In the described embodiment, the first table includes tasks to be performed inside of the home, the second table includes tasks to be performed outside the home, and the third table is other types of maintenance tasks. Because the described embodiment is intended primarily for use in the home, these particular table divisions well. In other applications, the tables can be divided based on different criteria, as appropriate. In some programming languages or program embodiments in which larger tables are permitted, it may be unnecessary to break the table down.

User Inputs

There are three user input tables:

1. User Name and Features

2. User Month Request

3. User Preferences

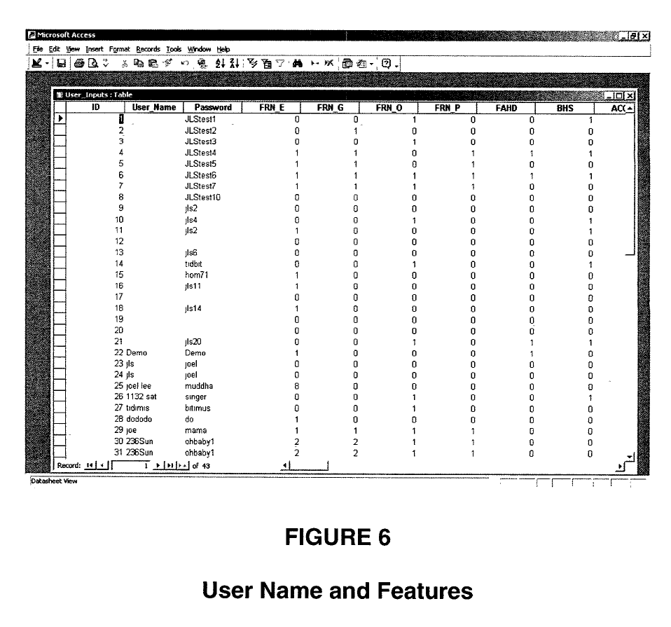

The “User Name and Features” table holds the data that is submitted by the user of software program. This data may be entered by the user using any of a variety of conventional input devices, such as a keyboard and a mouse, preferably using a graphical user interface. Data held in the table include the user's: name; password; and the particular features of the items for which they want to receive maintenance reminders. The potential features are the columns of the table, and a “1” is placed in record of the user for each feature that they select. See FIG. 6.

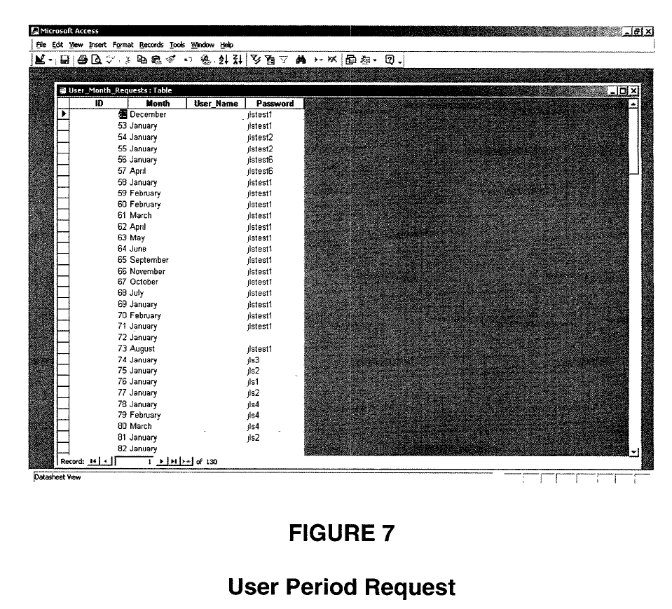

The “User Period Request” table holds the period, inputted by the user, for which the user wants see their recommended maintenance. See FIG. 7.

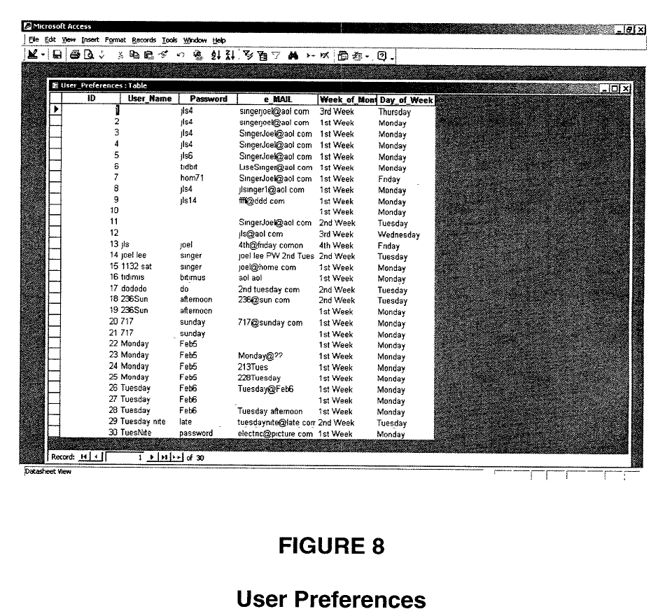

The “User Preferences” table holds the data provided by the user for how the user elects to be notified by the program (e.g., via e-mail). See Figure 8.

“Flippers”

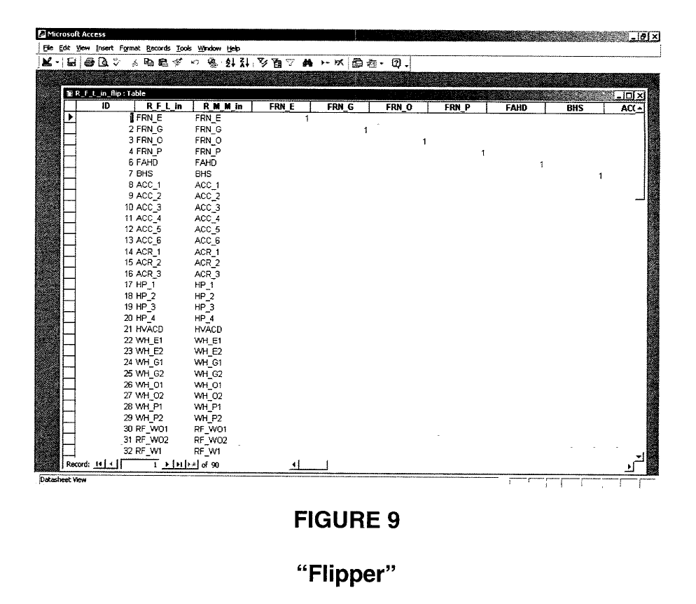

“Flippers” are tables that are designed to flip data that is in columns into data that is in rows. The purpose of this is to enable the program to make its comparisons that enable the identification of matches between a users particular features and the recommended maintenance schedule for these features (as described below in the section on “Flipped Data”). In the described embodiment, there are three separate flipper tables for flipping the data in the three separate Description of Maintenance Task tables. See FIGS. 9, 10, and 11.

Key Queries

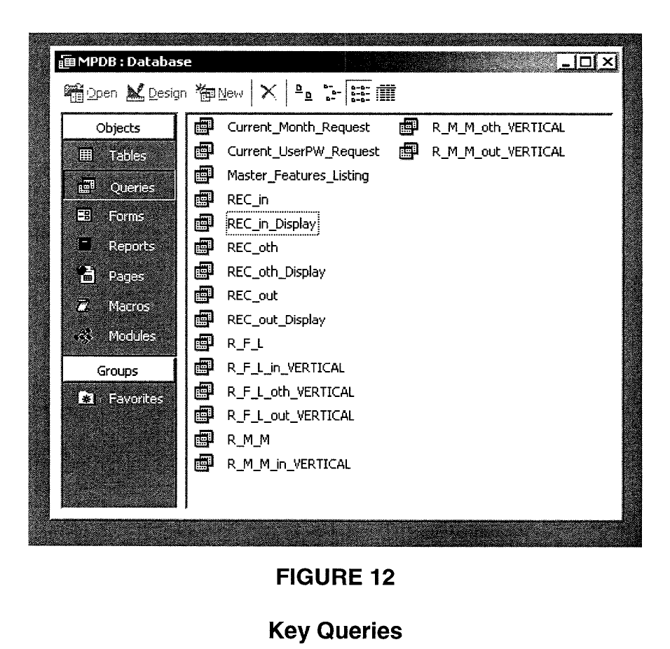

The software program utilizes seven key types of data queries (See FIG. 12):

Master Features List

Current User

Features of Current User

Features Due for Current Period

“Flipped Data”

Tasks Currently Due

Master Features List

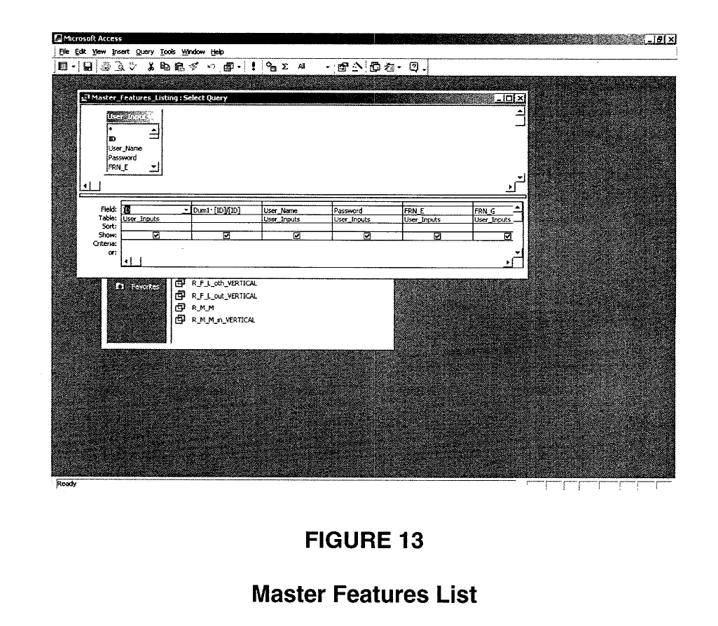

The “Master Features List” query takes data from the “User Input” table and expands the input to include maintenance tasks that correspond to the input that the user has provided. For example, if a user selects a water heater, then the Master Features List query would show a “1” in all of the columns related to water heater features that require maintenance. In addition, a “1” would be placed in the columns for all of the features that are common to all users (e.g., plumbing maintenance tasks for all users who have homes, since all homes are assumed to have plumbing). See FIG. 13.

Current User

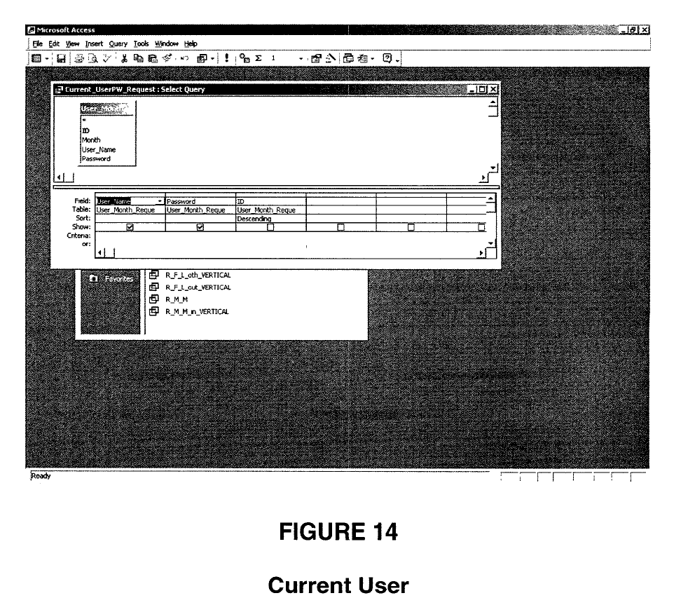

This query indicates who is the current user of the program (i.e., the last input into the program). See FIG. 14.

Current Period

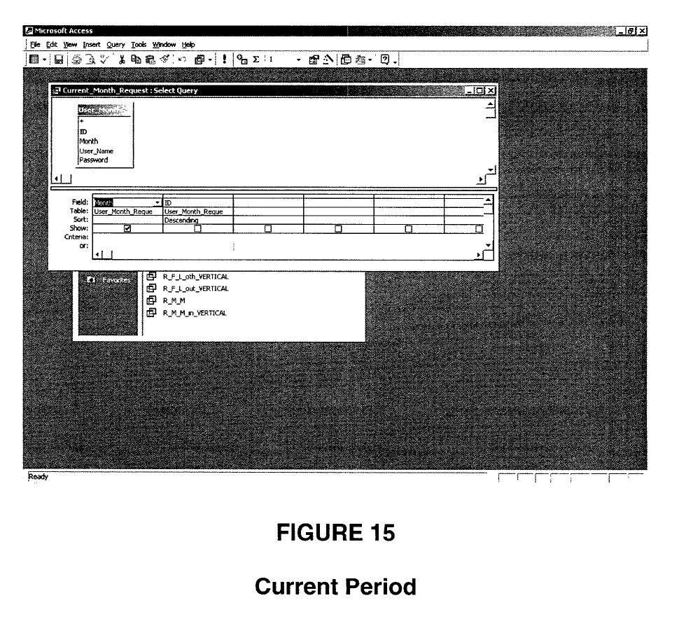

This query indicates the period that is being currently considered. See FIG. 15.

Features of Current User

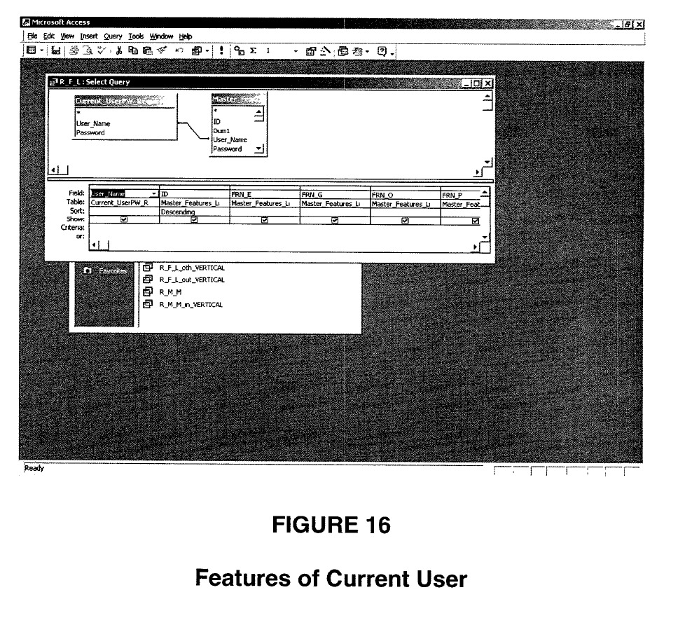

This query looks at the “Current User” and calls up the features for this user that have been saved for this user in the “User Name and Features” table. See FIG. 16.

Tasks Due for Current Period

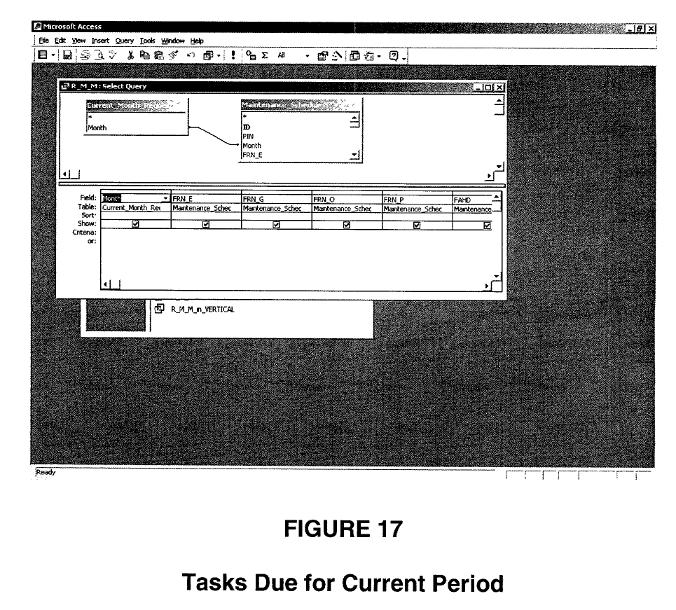

This query looks at the “Current Period” and calls up the tasks that have been saved in the “Maintenance Schedules” table. See FIG. 17.

“Flipped Data”

There are six queries that work with the “Flipper” tables above to change data that is in columns into data that is in rows.

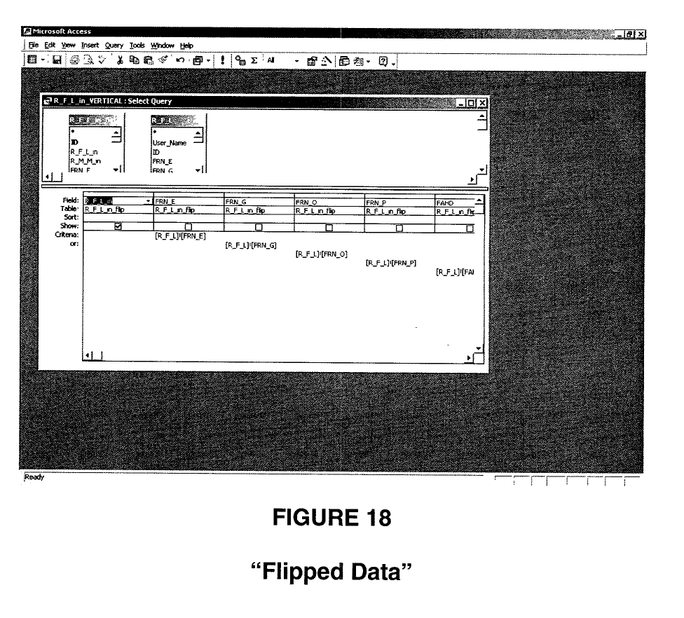

Three of these queries work with the “Features of the Current User”. Three queries are used because of the large size of the database requires the list of features to be broken into three parts. See FIGS. 18, 19, and 20.

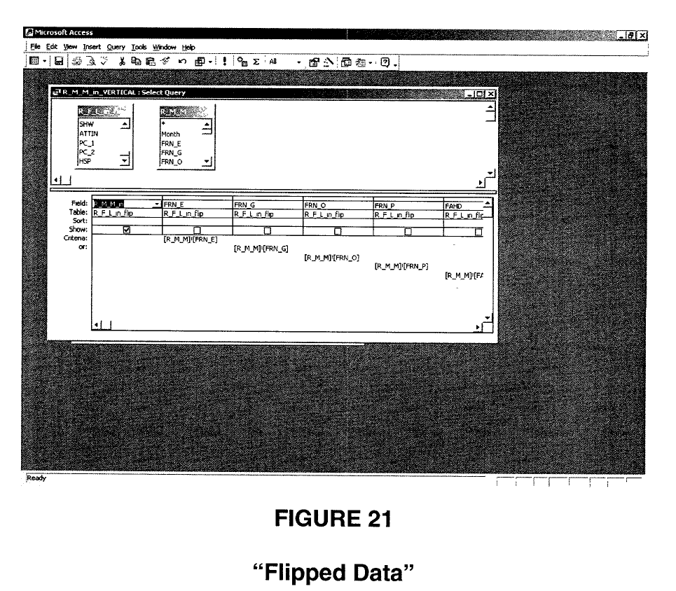

The other three queries work with the “Tasks Due for Current Period”. Again, three queries are used because of the large size of the database requires the list of features to be broken into three parts. See FIGS. 21, 22, and 23.

Tasks Currently Due (Matches between “Features of Current User” and “Tasks Due for Current Period”)

There are three queries that determine the specific maintenance tasks that are due for the current user based on the current period requested. As above, three queries are used because of the large size of the database requires the list of features to be broken into three parts.

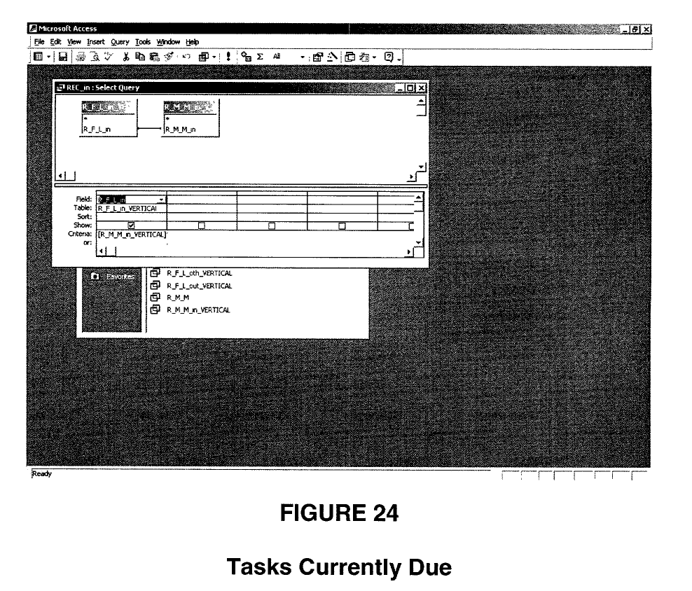

The queries compare the outputs from three corresponding sections of the “Features of Current User” and “Tasks Due for Current Period”, and determine where there are specific matches. See FIGS. 24, 25, and 26.

Displays of “Descriptions of Maintenance Tasks” of Tasks Currently Due for Current User

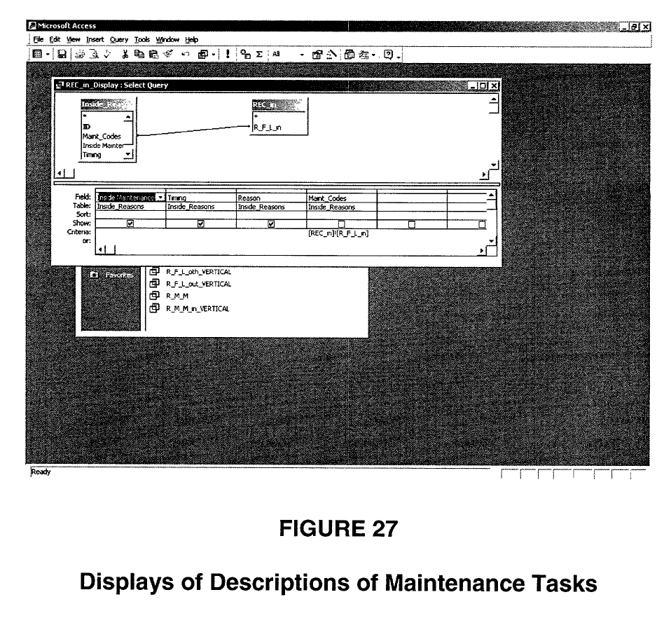

These queries take the output of the “Tasks Currently Due” above, and compare it to the “Descriptions of Maintenance Tasks” table, and then select the descriptions that match the tasks that are currently due. As above, three queries are used because of the large size of the database requires the list of features to be broken into three parts. See FIGS. 27, 28, and 29.

The output of this query forms one or more maintenance reminders that can be displayed or otherwise provided to the user to show them the tasks that are currently due, along with a brief description of the task, its recommended timing, and its rationale. The output of this query can be varied to alter the content of the maintenance reminder, for example, the output can be limited to maintenance tasks that relate to safety or energy savings.

In operation, the computer system periodically runs the above-described queries for all users in the system to determine all maintenance reminders for all users for that period. For example, the preferred periodic interval is monthly. With this interval, the computer system will automatically run the maintenance reminder queries once per month (e.g. on the first day of each month) to generate the maintenance reminders applicable to that month for all users. The monthly maintenance reminders generated by this monthly query are then provided to the appropriate users using any of the various communication mechanisms described herein.

The output of this query can also be integrated with other applications that enable the user to access a library that describes the maintenance tasks, an application that helps the user find local contractors, customized queries that allow the user to see only safety or energy-saving maintenance tasks, etc.

Included with this written description is a pictorial perspective of this invention that includes high-level process/data flow diagrams and high-level descriptions of four key data processing elements within the invention. This pictorial perspective, coupled with the above description of the invention enables a reader with the knowledge to comprehend and duplicate this invention. Also included with the written description, as Appendix 1 is a CD-ROM containing a database and web pages.

Having now described a preferred embodiment of the invention, it should be apparent to those skilled in the art that the foregoing is Illustrative only and not limiting, having been presented by way of example only. All the features disclosed in this specification may be replaced by alternative features serving the same purpose, and equivalents or similar purpose, unless expressly stated otherwise. Therefore, numerous other embodiments of the modifications thereof are contemplated as falling within the scope of the present invention as defined by the appended claims and equivalents thereto.

Moreover, the techniques described herein may be implemented in hardware or software or a combination of the two. Preferably, the techniques are implemented in computer programs executing on programmable computers that each include a processors, a storage medium readable by the processor, volatile and non-volatile memory and/or storage elements, at least one input device and one or more output devices. Program code is applied to data entered using the input device to perform the functions described and to generate output information. The output information is applied to one or more output devices.

Each program is preferably implemented in a high-level procedural or object oriented programming language to communicate with a computer system, however, the programs can be implemented in assembly or machine language, if desired. In any case, the language may be a compiled or interpreted language.

Each such program is preferably stored on a storage medium or device (e.g., CD-ROM, hard disk or magnetic diskette or the like) that is readable by a general or special purpose programmable computer for configuring and operating the computer when the storage medium or device is read by the computer to perform the procedures described in this document. The system may also be considered to be implemented as a computer-readable storage medium, configured with a computer program, where the storage medium so configured causes a computer to operate in a specific and predefined manner.

The embodiments of the invention in which an exclusive property or privilege is claimed are defined as follows:

1. A computer system for providing automated reminders comprising:
memory means within a computer containing an object database of scheduled maintenance information for a plurality of distinct objects;
user input means for a user to enter into said computer a list of one or more of said distinct objects;
means within the computer for retrieving said scheduled maintenance information from said object database for each object in said list;
means for building within said computer a schedule of maintenance reminders for each object in said list based on said scheduled maintenance information retrieved from said database; and
reminder means for periodically transmitting to the user said maintenance reminders for each object in said list, each transmission containing said maintenance reminders for a corresponding interval of time.

2. The computer system of claim 1 wherein said reminder means is further defined as at least one of the following: means for transmitting said maintenance reminders in an email; means for transmitting said maintenance reminders in an electronic facsimile; means for generating a mailing to be forwarded to a user by regular mail; means for transmitting said maintenance reminders in a voicemail using automated text-to-speech conversion; means for displaying said maintenance reminders on a website accessible to a user; and means for transmitting said maintenance reminders to an electronic pager.

3. The computer system of claim 2 further comprising memory means within the computer containing a database of contact information concerning service providers capable of performing maintenance indicated in said maintenance reminders or providers capable of providing components used in maintenance indicated in said maintenance reminders; and
wherein said reminder means further includes means for transmitting with said maintenance reminders contact information for one or more of said service providers capable of performing maintenance indicated in said maintenance reminders or providers capable of providing components used in maintenance indicated in said maintenance reminders.

4. The computer system of claim 3 wherein said reminder means is further defined as a website accessible to the user, said website displaying said maintenance reminders and said contact information for said service providers, said contact information including an Internet link to said service provider.

5. The computer system of claim 4 wherein said user input means is further defined as a website accessible to the user, said website including a list of objects contained in said object database, and means for the user to select objects from said list of objects.

6. The computer system of claim 5 wherein said object database further includes instructions for performing maintenance on said objects; and
said reminder means further includes means for transmitting with said maintenance reminders instructions for performing maintenance indicated in said maintenance reminders.

7. The computer system of claim 6 wherein said object database further includes a purpose for performing maintenance on said objects; and
said reminder means further including means for transmitting with said maintenance reminders said purpose for performing maintenance indicated in said maintenance reminders.

8. The computer system of claim 7 further comprising means for the user to input a specific schedule period, said reminder means including means for transmitting said maintenance reminders to said user for said specific schedule period.

9. The computer system of claim 8 further comprising means for storing an identification for each user, means for storing each of said list of objects and means for associating each user with a corresponding one of said stored list of objects.

10. A method for providing automated maintenance reminders via computer to a plurality of users, comprising the steps of:
building an object database within a computer containing maintenance information for a plurality of object, the object database including information concerning scheduled maintenance for each object;
inputting into the computer a list of one or more of the plurality of objects to be associated with a specific user;
comparing, within the computer, the list and the object database, and retrieving the scheduled maintenance information from the object database for each of the objects in the list;
building, within the computer, a schedule of maintenance reminders for each of the objects in the list based on the scheduled maintenance information retrieved from said database;
periodically transmitting to the user the maintenance reminders, each transmission containing the maintenance reminders for a corresponding interval of time; and
repeating said inputting, said comparing, said building and said transmitting steps for each separate user to receive maintenance reminders using the same object database.

11. The method of claim 10 wherein said transmitting step is further defined as at least one of the following: transmitting the maintenance reminders via email; transmitting the maintenance reminders via electronic facsimile; generating a mailing containing the maintenance reminders to be forwarded to the user by regular mail; transmitting the maintenance reminders in a voicemail via automated text-to-speech conversion; displaying the maintenance reminders on a website accessible to a user; and transmitting the maintenance reminders via electronic pager.

12. The method of claim 11 further comprising the steps of:
storing within the computer a database of contact information concerning providers capable of performing maintenance indicated in the maintenance reminders or capable of providing products used in performing maintenance indicated in the maintenance reminders; and
transmitting with the maintenance reminders contact information for one or more of the providers capable of performing maintenance indicated in the maintenance reminders or capable of providing products used in performing maintenance indicated in the maintenance reminders.

13. The method of claim 12 wherein said transmitting step includes displaying the maintenance reminders and the contact information for the provider on a website, the contact information including an Internet link to the provider.

14. The method of claim 13 wherein said inputting step includes the steps of displaying a list of objects contained in the object database on a website, and selecting on the website the objects from the displayed said list of objects for which the user would like automated reminders.

15. The method of claim 14 wherein the object database further includes instructions for performing maintenance on the objects; and
said transmitting step includes transmitting with the maintenance reminders instructions for performing maintenance indicated in the maintenance reminders.

16. The method of claim 15 wherein the object database further includes a purpose for performing maintenance on the objects; and
said transmitting step includes transmitting with the maintenance reminders the purpose for performing maintenance indicated in the maintenance reminders.

16. The method of claim 15 further including the steps of inputting a specific schedule period and generating a maintenance reminder for the specific schedule period.

17. The method of claim 16 further including the steps of:
storing an identification for each user;
storing the list of objects for each user; and
providing an association between each user and the corresponding stored list of objects.

18. A web-based maintenance reminder system comprising:
memory means within a computer containing an object database of maintenance information for a plurality of distinct objects;
a graphical user interface for displaying said plurality of distinct objects and for permitting a user to generate a list containing the objects for which the user would like to receive maintenance reminders;
means within the computer for storing a plurality of said lists, each of said lists being uniquely associated with a corresponding user;
means within the computer for retrieving maintenance information from said object database for each object in each of said lists;
means for building within said computer a schedule of maintenance reminders for each user, each maintenance reminder based on said time-based information retrieved from said object database, each schedule of maintenance reminders containing all maintenance reminders for each object in the object list associated with the corresponding user; and
reminder means for periodically transmitting to each user said maintenance reminders for a corresponding interval of time, each transmission containing said maintenance reminders unique to each user based on said list associated with said user.
